(19) United States
(12) Patent Application Publication
(10) Pub. No.: US 2009/0183810 A1
(43) Pub. Date: Jul. 23, 2009

(54) Newly manufactured airless or pneumatic tire having a reinforced rubber structure and a polyurethane tread

(76) Inventors: Frederick Forbes Vannan, Clinton, OH (US); Mark Howard Dickerhoof, Clinton, OH (US)

Correspondence Address: Frederick F. Vannan, 8509 Foxglove Ave. NW, Clinton, OH, 44216, US

(21) Appl. No.: 12/009,918

(22) Filed: Jan. 23, 2008

(51) Int. Cl. B60C 11/00

(52) U.S. Cl. 152/209.1

(57) ABSTRACT

This invention pertains to a newly manufactured airless or pneumatic tire having a rubber structure and a polyurethane tread.

### BACKGROUND

The field of this invention is tires which have been made entirely of rubber for about one hundred years. Most pneumatic tires are made from a combination of natural rubber and synthetic rubber. Rubber has been the only material capable of holding inflation pressure in a flexible air container, carrying a load and remaining durable in a difficult operating environment. Today's tire is longer wearing, more tractive, tougher to puncture and much safer than its predecessors and the cost per mile is significantly less than it was in the past.

The tire market is very competitive and tires are purchased based on performance versus price. Tread wear, traction, durability, comfortable ride.

and fuel economy are the most important performance parameters in the market place.

Carbon black is added to tires to improve tread wear and reduce cost. It causes all tires to have black treads which can put black marks on pavement and driveways if any slippage occurs. This is a problem for tread wear causes all rubber treads to have a black color.

Rubber is inherently hysteretic, absorbing energy and causing a rubber treaded tire to heat up during service adversely affecting durability and increasing rolling resistance which reduces vehicle fuel economy. Pneumatic rubber treaded tires are expanded into vulcanizing molds using high internal pressure. When these tires are removed from the mold and inflated to a significantly lower pressure for service, they are significantly less round than their tread mold causing a less comfortable vehicle ride. Rubber treaded tires also exhibit internal stresses adversely affecting durability and caused by expansion of the tire into the tread portion of the mold.

### SUMMARY OF INVENTION

The newly manufactured tire of this invention includes a vulcanized rubber structure which can utilize reinforcing textiles and wires to contain internal inflation pressure and control dimensions and shape of the finished tire.

The tire of this invention also includes a polyurethane tread. Polyurethane is less hysteretic than rubber which causes a polyurethane treaded tire to run cooler than a rubber treaded tire enhancing durability in service. Also the lower hysteresis of polyurethane lowers rolling resistance and improves fuel economy of polyurethane treaded tires relative to rubber treaded tires.

Polyurethane can be formulated to have significantly more abrasion resistance than rubber improving tread wear over rubber treaded tires.

### DESCRIPTION OF DRAWINGS

FIG. 1 shows a cross section and FIG. 2 shows an isometric view of the pneumatic tire 10 having a reinforced rubber structure 12 and a polyurethane tread 14.

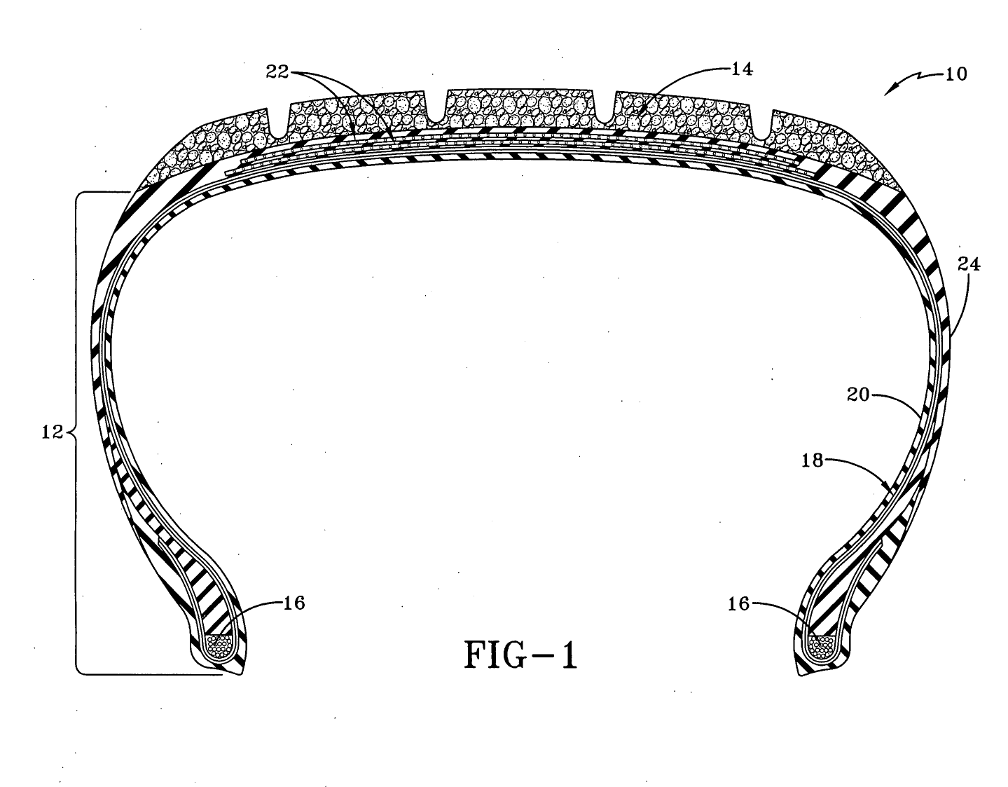

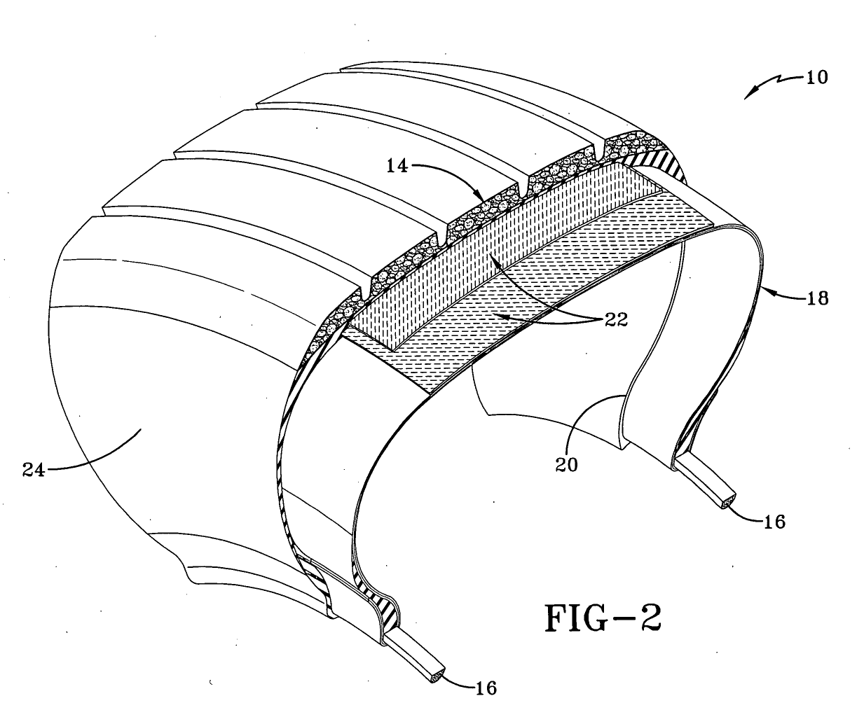

The vulcanized rubber structure 12 in FIG. 1 is reinforced by at least two beads 16 and at least one ply 18 and at least one belt 22. Additional components shown in FIGS. 1 and 2 are: innerliner 20 and sidewalls 24.

The tire 10 shown in FIGS. 1 and 2 is a very elementary passenger tire; however, all sizes and types of tires are included in this patent.

### DETAILED DESCRIPTION

The tire of this invention includes a vulcanized rubber structure utilizing reinforcing plies, belts, beads and other rubber components to contain internal inflation pressure and to control dimensions and shape of the finished tire.

The tire of this invention also includes a polyurethane tread which can be spliceless or have a tread splice. Most rubber treaded tires have a tread splice which can cause ride and durability problems in service. Polyurethane can be formulated to be any desired color without a performance penalty but rubber can only be black if it is formulated to be durable enough for a tire tread.

Polyurethane can be formulated to not mark pavement as all rubber treaded tires do. This is a particular advantage for landscapers and building contractors whose vehicles with rubber treaded tires mark concrete driveways requiring labor to remove the unsightly black rubber tread marks.

Rubber treaded pneumatic tires are expanded or stretched into their vulcanizing mold using high internal inflation pressure. When a rubber tire is subsequently inflated for service to a much lower pressure, it's roundness and shape are controlled by it's reinforcement geometry and it cannot be as round as the mold in which is was vulcanized. The polyurethane treaded tire of this invention can be as round, when inflated for service, as the tread mold which produced it because the vulcanized reinforced rubber structure is inflated to the same internal pressure inside the tread mold as it is in service. In service the roundness and tread shape will be the same as the mold delivering a smoother ride and better tread wear and traction than is possible with a rubber treaded tire.

Because the vulcanized reinforced rubber structure is inflated to operating pressure inside its tread mold and liquid polyurethane fills the space between the inflated rubber structure and the tread mold and the liquid polyurethane subsequently solidifies while in the mold, detrimental internal stresses inside this tire will be significantly less than in a rubber treaded tire.

The vulcanized reinforced rubber structure can have a texturized surface in the area where the polyurethane tread will be applied to promote adhesion to the polyurethane tread in service. The desired texturizing is built into the vulcanizing mold.

1. A newly manufactured airless tire having a rubber structure and a polyurethane tread.

2. A newly manufactured pneumatic tire having a reinforced rubber structure and a spliceless polyurethane tread.

3. The tire of claim 2 having a polyurethane tread splice.

4. The tire of claim 1 with a colored polyurethane tread.

5. The tire of claim 2 with a colored polyurethane tread.

6. The tire of claim 1 with a polyurethane tread material that will not mark pavement.

7. The tire of claim 2 with a polyurethane tread material that will not mark pavement.

8. The tire of claim 1 wherein the tread area of the rubber portion is texturized to promote adhesion to the polyurethane tread.

9. The tire of claim 2 wherein the tread area of the rubber portion is texturized to promote adhesion to the polyurethane tread.

10. The tire of claim 2 which when inflated is closer to the roundness of its tread mold than is a rubber tire.

11. The tire of claim 2 having less internal stresses than a comparable rubber treaded tire.

12. The tire of claim 1 having a polyurethane tread material that is longer wearing than rubber.

13. The tire of claim 2 having a polyurethane tread material that is longer wearing than rubber.

14. The tire of claim 1 having a polyurethane tread material that has lower rolling resistance than rubber.

15. The tire of claim 2 having a polyurethane tread material that has lower rolling resistance than rubber.
